(19) United States
(12) Patent Application Publication
(10) Pub. No.: US 2013/0061233 A1
(43) Pub. Date: Mar. 7, 2013

(54) EFFICIENT METHOD FOR THE SCHEDULING OF WORK LOADS IN A MULTI-CORE COMPUTING ENVIRONMENT

(71) Applicants: Xinliang ZHOU, Brossard (CA); Wei Huang, Pierrefonds (CA)

(72) Inventors: Xinliang ZHOU, Brossard (CA); Wei Huang, Pierrefonds (CA)

(73) Assignee: EXLUDUS INC., Montreal (CA)

(21) Appl. No.: 13/602,607

(22) Filed: Sep. 4, 2012

Related U.S. Application Data
(60) Provisional application No. 61/530,451, filed on Sep. 2, 2011.

(51) Int. Cl. G06F 9/50

(52) U.S. Cl. 718/103; 718/104

(57) ABSTRACT

A computer in which a single queue is used to implement all of the scheduling functionalities of shared computer resources in a multi-core computing environment. The length of the queue is determined uniquely by the relationship between the number of available work units and the number of available processing cores. Each work unit in the queue is assigned an execution token. The value of the execution token represents an amount of computing resources allocated for the work unit. Work units having non-zero execution tokens are processed using the computing resources allocate to each one of them. When a running work unit is finished, suspended or blocked, the value of the execution token of at least one other work unit in the queue is adjusted based on the amount of computing resources released by the running work unit.

### BACKGROUND

(a) Field

The subject matter disclosed generally relates to systems and methods for the scheduling of work load segments on computing facilities having multi-core processors.

(b) Related Prior Art

Processor core counts are rising at a dramatic rate. Today, even modestly priced servers may have 48 or more cores. However, since most applications are serial (or only lightly parallel) designs they are unable to effectively use many cores concurrently. To take advantage of multicore aggregate computing capacity users must run many concurrent tasks with each task consuming a (relatively) small percentage of the total system capacity, which in turn increases the likelihood of shared system resource conflicts and related performance degradations and/or system instability. This is especially true as the rate of core count increase continues to exceed that of memory capacity increase, meaning that the average memory capacity-per-core in these systems is decreasing and resource conflicts are becoming more likely.

FIG. 2 is a block diagram illustrating the structure of a conventional resource scheduling system used in computing facilities of various types. The main components of such a system include a supply of computational resources that can be partitioned amongst a list of tasks waiting for access to such resources, a plurality of queues of tasks for each processor (aka processing unit) each queue including a number of tasks waiting to be processed by the resources, a scheduling mechanism that can carry out the allocation of resources against the pending tasks, and a list of scheduling rules by which the allocation mechanism is implemented.

In the system illustrated in FIG. 2, the Job Scheduler is responsible for the ordering of the submission of jobs, which may consist of one or more tasks, for processing on the computing facility. The ordering imposed by the Job Scheduler is typically based on a set of rules that consider the priority of the jobs waiting for processing. The specific nature of the ordering scheme may take into account arbitrary partitions of the job stream based on, for example, job class differentiators such as the urgency of the processing results, the scale of resource requirements for the job, the identity of the job submitter, and various other requirements of a particular application.

The Task Scheduler has the responsibility of allocating computing resources to the list of tasks pending execution on the processing system in a manner dictated by the scheduling requirements defined for the specific processing system. In shared environments, the typical scheduling requirement is to consume the available processing resources of the computer system as efficiently as is possible while simultaneously sharing those resources with the competing tasks.

The Task Scheduler modifies the state of the tasks in the queues according to the relationship between the availability of needed computer resources by the tasks. The states of the tasks in the queues transition between running (when all needed resources are allocated), and various modes of waiting (when some or all of the needed resources are not available, or when the tasks themselves release their resources pending some asynchronous event completion).

There are a large number and varieties of computer scheduling algorithms on the market and their implementations are known in the field of computer science. Most of these algorithms are aimed at attaining a specified result in terms of measurable quantities a total job throughput, fair sharing of available resources, constrained priority based usage, or maximization of computing resource usage.

The mechanism employed in the methods found in the prior art involves a process of matching the availability of computing resources on a computer system to the availability of work units according to a specific scheduling criterion. For example, scheduling in a time sharing system implements a scheme that dispatches work units for processing based on the simple division of time by the number of work units in the request queues. A priority based system implements a scheme that dispatches work units based on various forms of priority being assigned to pending work units. Real time scheduling systems care only for the immediate needs of a work unit based on the occurrence of an external event.

Various hybrid scheduling systems are known in the prior art which mitigate the behavior of the generic scheduling modes for specific application needs. Examples include the implementation of priority aging in time sharing schedulers, the use of quota restrictions in priority schedulers, and the combination of real time scheduling with the other basic forms of schedulers, most commonly for the handling of asynchronous devices.

In view of the highlighted issues, improvements relating to multi-core processing and memory environment are desired.

### SUMMARY

According to an aspect, there is provided a method for maximizing use of computing resources in a multi-core computing environment, said method comprising: implementing all work units of said computing environment in a single queue; assigning an execution token to each work unit in the queue; allocating an amount of computing resources to each work unit, the amount of computing resources being proportional to a value of the execution token of the corresponding work unit; processing work units having non-zero execution tokens using the computing resources allocated to each work unit; when a running work unit is finished, suspended or blocked, adjusting the value of the execution token of at least one other work unit in the queue to maximize use of computing resources released by the running work unit.

The method may further comprise setting a minimum length of the queue to be equal to the number of processing cores in the computing environment.

In an embodiment, the method comprises setting the maximum length of the queue to be equal to the number of available work units.

The method may also include setting a priority key for each work unit in the queue, said priority key being different from the execution token, and having a value representing an execution priority of said work unit in the queue. In this case the method may also include creating a dummy work adapted to consume all computing resources allocated thereto; setting a variable execution token to said dummy work unit to allocate a variable amount/number of computing resources to said dummy work unit; and adding said dummy work unit to said queue to consume unused computing resources.

In an embodiment, the method may include setting the lowest priority key to said dummy work unit in the queue, whereby the dummy work unit is only processed when there is a lack of work units in the queue.

In a further embodiment, the method may include reducing the execution token of a running dummy work unit when a new work unit is added in the queue.

In yet a further embodiment, the method may include suspending a running dummy work unit when other work units in the queue consume all available computing resources in the computing environment.

In an embodiment, the aggregate value of all execution tokens of all work units is equal to the number of processing cores of said computing environment. In the present embodiment, the value of the execution token may be an integer that represents the number of processing cores allocated to the corresponding work unit.

In another embodiment, an aggregate value of all execution tokens is greater than the number of computing resources of said computing environment, the method further comprising oversubscribing said processing cores; and partitioning said processing cores among all work units in the queue.

In yet a further embodiment, the shared resources include: central processing units, processing cores of a single central processing unit, memory locations, memory bandwidth, input/output channels, external storage devices, network communications bandwidth.

According to another aspect there is provided a computer having shared computing resources including at least one processor comprising a plurality of processing cores and a memory having recorded thereon computer readable instructions for execution by the processor for maximizing use of the computing resources in the computer, the instructions causing the computer to implement the steps of: implementing all work units of said computer in a single queue; assigning an execution token to each work unit in the queue; allocating an amount of computing resources to each work unit, the amount of computing resources being proportional to a value of the execution token of the corresponding work unit; processing work units having non-zero execution tokens using the computing resources allocated to each work unit; when a running work unit is finished, suspended or blocked, adjusting the value of the execution token of at least one other work unit in the queue to maximize use of computing resources released by the running work unit.

In an embodiment, the length of the queue is variable and having a minimum which is equal to the number of processing cores in the computer and a maximum which is equal to the number of available work units.

In another embodiment, the computer is adapted to set a priority key for each work unit in the queue, the priority key being different from the execution token and having a value representing an execution priority of said work unit in the queue.

In a further embodiment, the computer is adapted to create a dummy work adapted to consume all computing resources allocated thereto; set a variable execution token to said dummy work unit to allocate a variable amount/number of computing resources to said dummy work unit; and add said dummy work unit to said queue to consume unused computing resources.

In yet another embodiment, the computer is further adapted to set the lowest priority key to the dummy work unit in the queue, whereby the dummy work unit is only processed when there is no work units in the queue or when the work units in the queue cannot use all the available computing resources of the computer.

In an embodiment, the aggregate value aggregate value of all execution tokens of all work units is equal to the number of processing cores of said computing environment, the value of each execution token representing the number processing cores allocated to the corresponding work unit.

In another embodiment, the aggregate value of all execution tokens is greater than the number of computing resources of said computing environment, the computer being further adapted to oversubscribe said processing cores; and partition the processing cores among all work units in the queue.

According to a further aspect, there is provided a method for maximizing use of computing resources in a multi-core computing environment, said method comprising: implementing all work units of said computing environment in a single queue having a variable length, said variable length extending between the number of processing cores as a minimum and the number of available work units as a maximum; assigning an execution token to each work unit in the queue; allocating an amount of computing resources to each work unit, the amount of computing resources being proportional to a value of the execution token of the corresponding work unit; setting a priority key different from the execution token to each work unit for prioritizing processing of the work units in the queue; inserting newly received work units in the queue based on the priority key associated with each newly received work unit; processing work units having non-zero execution tokens using the computing resources allocated to each work unit; and when a running work unit is finished, suspended or blocked, adjusting the value of the execution token of at least one other work unit in the queue to maximize use of computing resources released by the running work unit.

According to another embodiment, there is provided a computer having access to statements and instructions for implementing the above methods.

The following terms are defined below:

A multi-core processing element of a computer system is a processing unit that embodies more than one autonomous processing units, each of which is capable of operating on a stream of stream of instructions supplied to the processing unit via access to some suitable storage medium for digital information, such as a computer memory system, a data storage device, a communication channel or any other device capable of feeding an instruction stream to the processing unit.

A computer system which may consist of a number of processing elements, each of which contains multiple processing units, each of which may themselves incorporate arrays of processing cores is also a multi-core processing environment for the purposes of the claims of this patent. Examples of such multi-core computing environments include arrays of independent computer systems, each one of which contains one or more multi-core processors.

An autonomous processing unit means a unit of computer hardware that is capable on its own of accepting a stream of instructions which represent processing operations on a processing unit and which is capable of executing the stream of instructions without recourse to external processing resources. The processing unit itself embodies a completely functional sequential finite state computing engine for the definition of all of the operations that can be embedded within the instruction stream.

A unit of work for a processing unit of a multi-core computing environment is a sequence of instructions that can be executed on a single processing unit of a multi-core computing environment. The sequence of instructions may consist of all of the instructions that implement a complete computer program that is implemented using the instruction set for a specified processing unit, or may consist of any convenient part of a computer program that is implemented using the instruction set specified for the relevant processing unit.

A job, a task, a work unit or a process are terms that variously refer to aggregations of the streams of processing instructions that can be executed on a specified processing unit or units of a computer system. The terms job, task and process severally refer to sets of processing instructions that are characterized by the fact that they are collections of processing unit instructions and not limited as to the number of instructions in a particular set.

A project is a collection of jobs, tasks or processes that are grouped together for administrative purposes. Within a project, the specific implementation at the level of an instruction set for a specific computer processing unit is neither homogeneous nor interdependent. The idea of a project is used here to describe a labeling that provides for an administrative convenience that enables some embodiments of the claimed invention to implement the optimization of the scheduling of work units over possibly heterogeneous and independent processing elements.

A data structure is a template that is used to assign names and relative locations and sizes to a collection of data elements used to represent the properties and state of specific work units being processed on a multi-core computing environment.

A queue is a linked list of data structure instances that describe the properties and states of a set of work units being processed on a multi-core computing system.

A scheduler is a process running on a computer system that is responsible for the allocation of real or virtual computer resources to work units that require such computer resources in order to effect the processing of the work units on the computer facility.

A scheduling algorithm is a set of rules that specify how computing resources should be allocated amongst a list of work units requiring such computing resources.

A processing resource or processing element is a physical resource that is needed for the execution of a work unit on a computer facility. Examples of processing resources include, but are not restricted to, central processing units, processing cores of a central processing unit, memory locations, memory bandwidth, input/output channels, external storage devices, network communications bandwidth and various types of computer hardware needed to implement data processing and communications operations.

### BRIEF DESCRIPTION OF THE DRAWINGS

Further features and advantages of the present disclosure will become apparent from the following detailed description, taken in combination with the appended drawings, in which:

FIG. 1 is a block diagram illustrating the hardware and operating environment in conjunction with which embodiments of the invention may be practiced;

FIG. 2 is a block diagram illustrating the structure of a conventional resource scheduling system;

FIG. 3 illustrates an example of a priority queue in accordance an embodiment;

FIG. 4 is a block diagram illustrating valid transitions between the different states of a work unit;

FIG. 5 is a flowchart of a method for maximizing use of computing resources in a multi-core computing environment, in accordance with an embodiment; and

FIG. 6 is flowchart of a method for maximizing use of computing resources in a multi-core computing environment, in accordance with another embodiment.

It will be noted that throughout the appended drawings, like features are identified by like reference numerals.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### DETAILED DESCRIPTION

The present document describes a computing system and method in which a single queue is used to implement all of the functionalities and features of the optimal scheduling of shared computer resources over an entire array of processing units in a multi-core computing environment. The length of the queue is determined uniquely by the relationship between the number of available work units and the number of available processing cores. Each work unit in the queue is assigned an execution token. The value of the execution token represents an amount of computing resources allocated for the work unit. Work units having non-zero execution tokens are processed using the computing resources allocate to each one of them. When a running work unit is finished, suspended or blocked, the value of the execution token of at least one other work unit in the queue is adjusted based on the amount of computing resources released by the running work unit.

### Hardware and Operating Environment

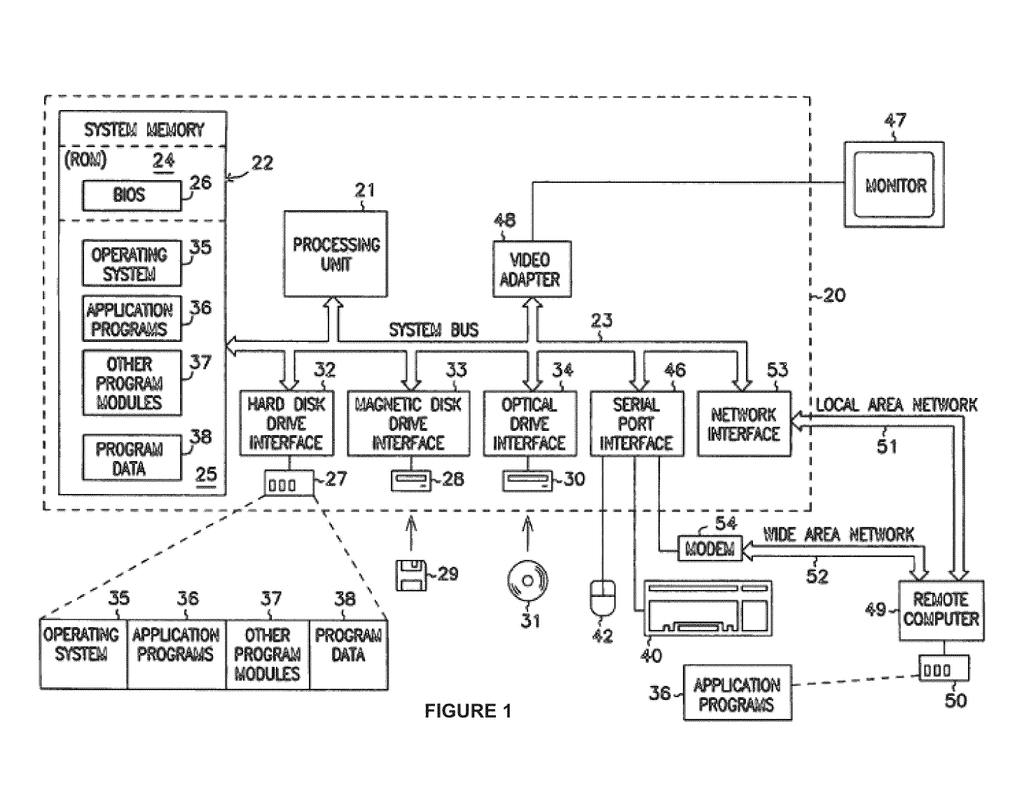

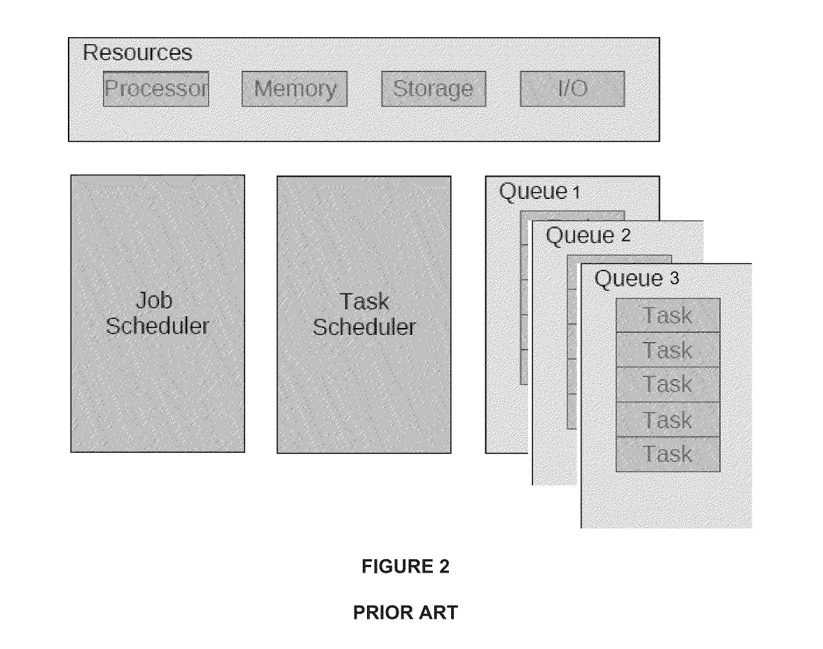

FIG. 1 is a diagram of the hardware and operating environment in conjunction with which embodiments of the invention may be practiced. The description of FIG. 1 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer, a hand-held or palm-size computer, or an embedded system such as a computer in a consumer device or specialized industrial controller. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The exemplary hardware and operating environment of FIG. 1 for implementing the invention may include a general purpose computing device in the form of a computer 20, including a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. In one embodiment of the invention, the computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. In alternative embodiments of the invention, the functionality provided by the hard disk drive 27, magnetic disk 29 and optical disk drive 30 is emulated using volatile or non-volatile RAM in order to conserve power and reduce the size of the system. In these alternative embodiments, the RAM may be fixed in the computer system, or it may be a removable RAM device, such as a Compact Flash memory card.

In an embodiment of the invention, the hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, touch sensitive pad, or the like. These and other input devices are often connected to the processing unit 21 through a serial port interface 46 that is coupled to the system bus, but may be connected by other interfaces, such as a parallel port, game port, or a universal serial bus (USB). In addition, input to the system may be provided by a microphone to receive audio input.

A monitor 47 or other type of display device may also be connected to the system bus 23 via an interface, such as a video adapter 48. In one embodiment of the invention, the monitor comprises a Liquid Crystal Display (LCD). In addition to the monitor, computers typically include other peripheral output devices (not shown), such as speakers and printers.

The computer 20 may operate in a networked environment using logical connections to one or more remote computers, such as a remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer, a hand-held or palm-size computer, a computer in an embedded system, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

Co-owned U.S. Patent Publication No. 20100043009 (application Ser. No. 12/543,498) entitled “Resource Allocation in Multi-Core Environments” (hereinafter US498) teaches a system and method for implementing a scheduling algorithm that is designed with the goal of ensuring maximum use of the available processing power of a multi-core computer system. Unlike traditional scheduler applications, the scheduling approach taught in US498 results in the maximization of computing resource consumption based on a method of heuristic rules that result in the dispatch of those pending work units that will keep the available shared computing resources of the processing facility as busy as possible given the available work units.

The mechanism taught in US498 uses a number of possible states between which a work unit submitted to a processing facility may transition to process the instruction stream of the work unit depending of the availability of shared resources. US498 specifies the rules of transition of a work unit between a number of queues. The transition rules specify the circumstances and route that work units may take while transitioning between the various queues. A generic embodiment of this scheme for a processing unit in a multi-core computer system might include an input queue, a wait queue, an execute queue and an output queue. The queues are not the queues of similar names that are typically found at the user interface level of an operating system. Instead, they are internal to the resource allocation and dispatch mechanism taught in the system.

However, the scalability of the scheduling and dispatch mechanism of the system taught in US498 is limited. In particular, as the load (in terms of work units) and the number of processing units (as measured by the number of cores in the system) increase, the lengths of the internal queues grows and the time needed to search the queue and reconcile the states of the work units in the queues against the established transition rules grows at a non-linear rate. The time required to update the states of work units in single queue grows with the number of work units in the queue. Where there are multiple queues, the rate of growth of the time required to reconcile the work units in the queues with the transition rules grows as the product of the number of queues and their lengths.

### EMBODIMENTS

Embodiments of the present invention describe a data structure, an algorithm for the management of the data structure as part of a reconciliation method that is used for the allocation of resources and the dispatching of work units which consume allocated resources, and a method of use of some mechanisms to handle situations where there are no work units for the available resources.

In an embodiment, a single queue is used to implement all of the functionalities and features of the optimal scheduling of shared computer resources over an entire array of processing units in a multi-core computing environment. As a result, the scalability issues associated with US498 are eliminated because there is only one queue. The length of the queue is determined uniquely by the relationship between the number of available work units and the number of available processing elements. In an embodiment, the minimum queue length is the number of processing elements in the multi-core computing environment, whereas the maximum length of the queue is determined by the number of available work units.

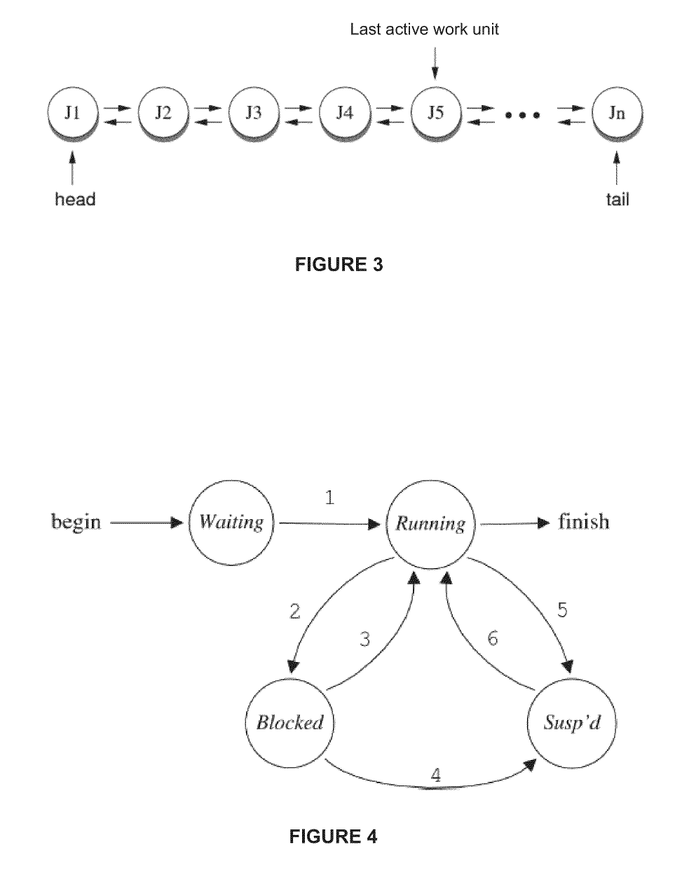

In one embodiment, the queue comprises a double linked list that implements a priority queue. The priority queue is characterized by a set of queue management functions that can add items to the queue based on a priority key. The essential feature of the priority queue is that the list is ordered based on the values of the priority key of the item, and the ordering is maintained under additions and deletions. In the general case, the priority key for an item can be any type of value for which a collating sequence can be established. An example of a priority queue in accordance with the present embodiments is illustrated in FIG. 3.

In another embodiment, the queue comprises a list of items which use an integer as the priority key. In this list, the items having higher integer values for the keys are provided ahead of those having a lower integer value for the keys. Embodiments of the present invention make use of a variety of priority key formats for application specific purposes. The specific format of the priority key does not limit the scope or applicability of the embodiments as long as the requirement of the existence of a collating algorithm for the key is met. Items added to a priority queue are inserted at a point in the queue between existing entries that have keys with collating sequence values that determine the location of the new item. For example, in embodiments using a descending collating value for their implementation, a new item is inserted below the first item with a higher collating sequence value for its key. In this particular embodiment, the priority key is a job dispatching priority value. Consequently, a work unit at the top (or front) of the queue is the work unit with the currently highest dispatching priority of all work units in the queue. Similarly, a work unit at the bottom (or back) of the queue is the one with the lowest dispatching priority of all work units in the queue.

In addition to the basic priority queue embodiment of the queue used in the present embodiments implement an additional pointer to work units present in the queue. In the present document, a pointer should be understood as an identifier that holds the location in the queue of a work unit. In an embodiment, the pointer is used to hold the current location of the last active work unit of the list of work units in the queue. An active work unit is a work unit that is currently running on the processing facility and consuming computing resources. In the example of FIG. 3, J5 is the last active work unit in the queue. Work units between J5 and Jn are in a waiting state.

The total number of work units that can be active on a processing facility is determined by the number of physical processing units that are available on the facility. In the present embodiments, a work unit can be active in the scheduling queue if and only if it is the holder of an execution token. The number of available processing/execution tokens is fixed at the number of available real or virtual processing units. In the case of virtual processing units, the value of execution tokens may represent either fractional parts of real processing resources, or multiples of real processing resources, any combination of processing resource units that is relevant to the specific application of the embodiment.”

### Execution Tokens

An execution token is an abstract entity, represented in the scheduling queue by a quantity in the queue entry that, in a generic sense, represents a quantity of processing resource that is available for allocation to a work unit for the purpose of processing the work of the work unit. Without limitation, the value of the execution token can represent any quantity, or a collection of quantities, of a virtual processing resource, such as a processor, a processor core, a percentage of a processor core or any values that may be convenient for the allocation of processing resources to a work unit.

In one embodiment, there is a one to one relationship between the total number of execution tokens available for allocation to work units and the total number of processing elements in the computer system. In an embodiment, the number of execution tokens allocated to a work unit is the number of processing elements that can be used to process the work of the work unit. For example, a work unit in the queue that has an execution token count of zero cannot be dispatched for execution. Also, on a processing facility with, for example, 12 processing cores, a work unit with an execution token count of 8 can be dispatched for execution on 8 of the 12 cores of the processing facility.

In another embodiment, the number of execution tokens available for allocation may exceed the number of processing elements of the computer system. In this embodiment, it is possible to oversubscribe the processing elements of the computer system, a strategy for ensuring the continuous availability of work for all of the processing elements of the system. In the present embodiment, the execution token value may be thought of as having a one to one relationship with a number of virtual processing elements of a computer system, the number of such elements being greater than the actual physical number of processing elements. In this case, the scheduling activity by a suitable work load management application may implement various forms of partitioning and sharing of the physical resources.

In a further embodiment, the value of the execution token represents a proportion of the available physical resources of the computer system, or a part thereof, such as a percentage of the total available resource available to a work unit. In this embodiment, the proportion of the processing resources may represent either a proportion of an actual physical resource or a proportion of a virtual resource. Scheduling strategies that perform the actual mapping between the eventual physical resources used to process a work unit and the work unit itself may implement application specific algorithms which can be tailored to application specific resource allocation and scheduling requirements.

In all of the above embodiments, the execution token represents to the scheduler the authorization to allocate a processing resource, or some proportion of a scheduler resource, to a work load unit. Work load units that have a value or zero for an execution token value cannot be scheduled for execution on the processing facility.

### The State of a Work Unit

A property of a work unit that is represented in the data structure for the work unit held in the queue is its current state. State transitions occur when a work unit acquires or relinquishes a processing resource, such as the processing core that runs its instructions. Computing resources such as a processing core, memory or any other allocatable computing resource may be acquired or released by a work unit according to the needs of the application. For example, a work unit may relinquish a processor element while an asynchronous input/output operation is completed.

The list of states defined for a work unit in the context of the present embodiments are defined as follows:
Waiting—The work unit is waiting for processing resources to become available;
Running—The work unit is ready to be executed on a processing element or elements;
Blocked—The work unit is waiting for the completion of a blocking event;
Suspended—The work unit has no computing resources allocated for its use.

An example of valid transitions between the states of a work unit is shown in FIG. 4. A work unit which is added to the scheduling queue initially enters the Waiting state. It has yet to acquire a non-zero execution token. As computing resources become available on the system, an allocation is made by the scheduler to the work unit. At the point where a work unit acquires an execution token value that has a non-zero value, the work unit enters the Running state.

In an embodiment, a work unit acquires a non-zero execution token value as a result of a scheduling operation that allocates processing resources to the work unit based of scheduling rules specific to the particular embodiment. Typical examples of scheduling rules include priority based scheduling, preemptive scheduling and many other techniques that have the effect of ordering the priority of work units in the queue.

Should the work unit interrupt its own processing in order to wait for the completion of a blocking operation, it relinquishes the value of the resources represented by its execution token and enters the Blocked state. The quantity of processing resource represented by the value of its execution token is made available to the scheduler process operating on the queue for re-allocation to other work units.

While a work unit is in the Blocked state, it may transition back to the Running state at the completion of the blocking operation by re-acquiring the computing resources represented by the value of its execution token, or it may transition to the Suspended state. Scheduler rules specific to the application of the present embodiments determine when a transition of a work unit from the Suspended state to the Running state occurs. Alternatively, the transition of a work unit from the Blocked state to the Suspended state can occur whenever a work unit of a higher priority acquires some or all of the computing resources represented by the value of the execution token of the work unit in the Blocked state.

Work units in the Suspended state can transition back to the Running state when an amount of computing resource equal to or greater than the value of the execution token becomes available for allocation to work units in the queue. Computing resources become available when a work unit in the Running state terminates, thereby releasing the computing resources represented by its execution token, or when action is taken by a scheduling operation re-assigns the resources represented by the execution token values or work units in the queue available for the processing facility. The mechanism of such scheduling operations is independent of the present embodiments, and may include actions such as the forced termination of one or more work units, abnormal termination of work units, the arrival of higher priority work units in the queue, or the adjustment of the relative priorities of work units in the queue.

### Operations on the Priority Queue

In an embodiment, the scheduling queue of the present embodiments can be represented as an indexed list, where the entry at the top of the queue has an index value of 0 and the entry at the bottom of the queue has an index value of N−1, where N is the number of entries in the list. The queue pointer to the last active job will have a value in the range 0 through N−1, subject to the condition that the value of the first active job pointer will be less than or equal to the value of the last active work unit pointer.

When a work unit leaves the Running state, it releases the processing resources represented by the value of its execution token. The processing resources represented by the value execution token are then made available for allocation to other, lower priority, work units in the queue. Selecting the next work unit or units to be placed into execution is carried out by moving the last active work unit pointer either towards the top (lower index values) or towards the bottom (higher index values) depending on the nature of the goal of the scheduling strategy.

There are three cases of relevance:

1. A work unit terminates and leaves the scheduling queue. In this case, the last active work unit pointer moves down the queue (towards higher index values) until it finds a work unit or work units that are in states that can consume the newly available computing resources. Such work units will have states that are either Suspended or Waiting. Allocation of the available processing resources to the available work units proceeds until they are consumed. The work units receiving the allocations transition their states to the Running state and the last active work unit pointer takes on the queue index value of the last work unit transitioned to the Running state.

2. A higher priority work unit arrives in the queue. The state of the new, higher priority, work unit is initially the Waiting state. In this case, the work unit whose current index value is equal to that of the last active work unit pointer is preempted by moving it into the Suspended state and the resources represented by the value of its execution token are released for re-allocation. This process continues until sufficient processing resources are liberated for the new arrival to be transitioned to the Running state. The last active work unit proceeds up the queue (towards lower index values).

3. A work unit that is in the Blocked state is woken up because the blocking operation that caused it to be transitioned into the Blocked state completes. In this case, the processing resources needed to transition the work unit back into the Running state are acquired by preempting work units in the Running state beginning with the work unit pointed to by the last active work unit pointer.

As with the case of the arrival of a higher priority work unit, successive preemption operations are carried out until sufficient processing resources are released to satisfy the needs of the work unit being transitioned out of the Blocked state.

For the purposes of the allocation of processing resources, the arrival in the queue of any work units with a priority key value lower than the work unit whose index is equal to the value of the last active work unit pointer are ignored. Such units take their place in the queue with a state of Waiting.

### Initialization and Deficiency Mechanisms

There are two situations where the number of work units in the queue may be insufficient to consume available processing resources:

1. When the process is starting up on a computing facility, there will be, in general, no work units in the scheduling queue, a situation that may persist for a considerable quantity of time.

2. When there are insufficient numbers of work units in the scheduling queue to consume all of the available computing resources. This situation can occur at any time in the operation of the computing facility and may persist for protracted periods.

In order to continue the operation of the present embodiments in cases of initialization or work load deficiency, the idea of a dummy work unit is used. A dummy work unit is a special entry in the scheduling queue which has the lowest possible value for its priority key. A dummy work unit has the following properties:

1. It will accept from the scheduler process amounts of allocatable computing resources up to and including the totality of all allocatable resources for the computing facility.

2. It is initially in the Running state, and can transition uniquely between the Running state and the Suspended state. The only time that the dummy work unit is in the Suspended state is when other work units in the queue are consuming all of the allocatable resources of the system.

3. The dummy work unit never leaves the queue.

4. The dummy work unit does no processing that is relevant to the operation of the scheduler algorithm.

5. The dummy work unit consumes resources allocated to it only in a virtual sense. For example, in an embodiment which uses processor cores as the only allocatable resource, the dummy work unit does not actually consume any of the processor cores when all such cores are allocated to it by the scheduler. In this instance, the allocation represents only an accounting entry.

6. The dummy work unit may have an arbitrary number of properties ascribed to it which are available to the scheduling and allocation mechanism for the purpose of managing the value of the execution token for the unit.

In an embodiment, every scheduling queue will have at least one dummy work unit entered at the lowest priority value and allocated all of the allocatable computing resources at initialization time. The last active work unit pointer will have a value that points to the first, or, only dummy work unit in the queue (depending on the case).

Any new work unit arriving in the scheduling queue will have a higher priority than the dummy work unit, and will, consequently, try to preempt the relevant dummy work unit to acquire resources to enter the Running state. In the case where there are no dummy work units in the Running state, there is no possibility for a preemptive recovery of an execution token value, and the new arrival enters the queue at its priority level and remains in the Waiting state. The last active work unit pointer remains unchanged.

In the case where there is a relevant dummy work unit with a non-zero execution token value, the scheduler will attempt to recover sufficient resources to enable transition of the new arrival to the Running state from the resources allocated to the dummy work unit. Again this recovery, if possible, represents only an accounting operation. Where the execution token value of the dummy work unit represents a resource quantity that exceeds the needs of the new arrival, the execution token value of the dummy work unit is decreased by the quantities needed by the new arrival, the new arrival is allocated to liberated resources and placed in the Running state, and the last active work unit pointer is modified to point to the queue index value of the new arrival. If the residual resource allocation to the dummy work unit is non-zero, the state of the dummy work unit remains unchanged as Running. If the residual resource quantity of the dummy work unit is zero, the state of the dummy work unit is transitioned to Suspended.

A deficiency situation occurs when the total of the allocatable resources of a computer system exceeds the total of the resources needed to process all of the work units in the scheduling queue. At initialization time, this is the situation, with all resources allocated to the pool of dummy work units in the queue. On a station that is overloaded with work, the pool of dummy work units will all have transitioned to the Suspended state, and with the ebb and flow of work demands on the system, excess resources are used to move dummy work units back to the Running state with, on an accounting basis, execution token values that represent unused computing resources.

In an embodiment, the number of dummy work units that exist in the scheduling queue can range from a minimum of 1 to a maximum value that is dependent on the specific nature of the embodiment. A simple embodiment that is used to schedule a small number of processor cores on a computer system may have a number of dummy work units exactly equal to the number of execution tokens available for allocation, where each execution token represents a single core of the computer systems processing unit. In this embodiment, each dummy work unit is allocated 1 processor core, and preemption operations by work units requiring, for instance, 2 cores, would be effected by preemption operations on 2 dummy work units.

Other embodiments have different implementation details for the handling of dummy work units. In particular, dummy work units may have attributes that are used to qualify scheduling behavior according to hardware architecture, resource reservations or any other useful attribute of the computer system that may be used to control its operation. By a considered application of a list of properties to dummy work units, the scheduling queue can be effectively partitioned according to the needs of the embodiment. For example, in cases where a computer system incorporates multiple processing elements of differing hardware architecture or performance, dummy work units may be defined with attributes that relate to different classes of architecture or performance. The schedule then will operate by adjusting the relevant execution token values of such dummy work units only when compatible processing resources are requested or freed.

In a similar fashion, dummy work units can be used to implicitly partition the scheduling queue by assigning properties that relate to aspects of the system operation such as job priority class. In such an embodiment, resource requests and dispositions are only considered based on the state of dummy work units that have matching class attributes. Such embodiments can be used, for example, to implement schemes of resource reservation on shared processing systems by simply creating dummy work units with a specified property attribute and an execution token value that is equal to the total resource allocation on the shared system for the matching class.

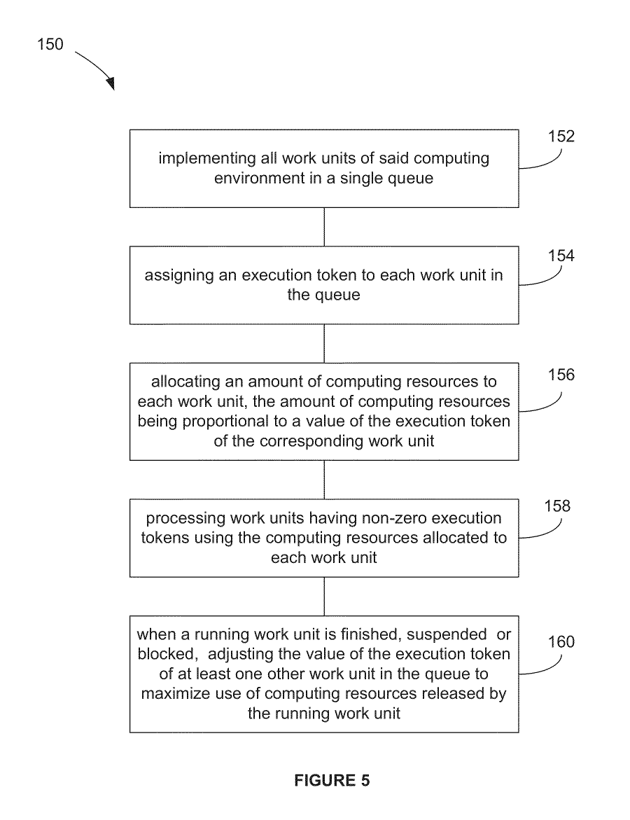

FIG. 5 is a flowchart of a method for maximizing use of computing resources in a multi-core computing environment, in accordance with an embodiment. As shown in FIG. 5, the method 150 begins at step 152 by implementing all work units of said computing environment in a single queue. Step 154 comprises assigning an execution token to each work unit in the queue. Step 156 comprises allocating an amount of computing resources to each work unit, the amount of computing resources being proportional to a value of the execution token of the corresponding work unit. Step 158 comprises processing work units having non-zero execution tokens using the computing resources allocated to each work unit. Step 160 comprises adjusting the value of the execution token of at least one other work unit in the queue to maximize use of computing resources released by the running work unit, when a running work unit is finished, suspended or blocked.

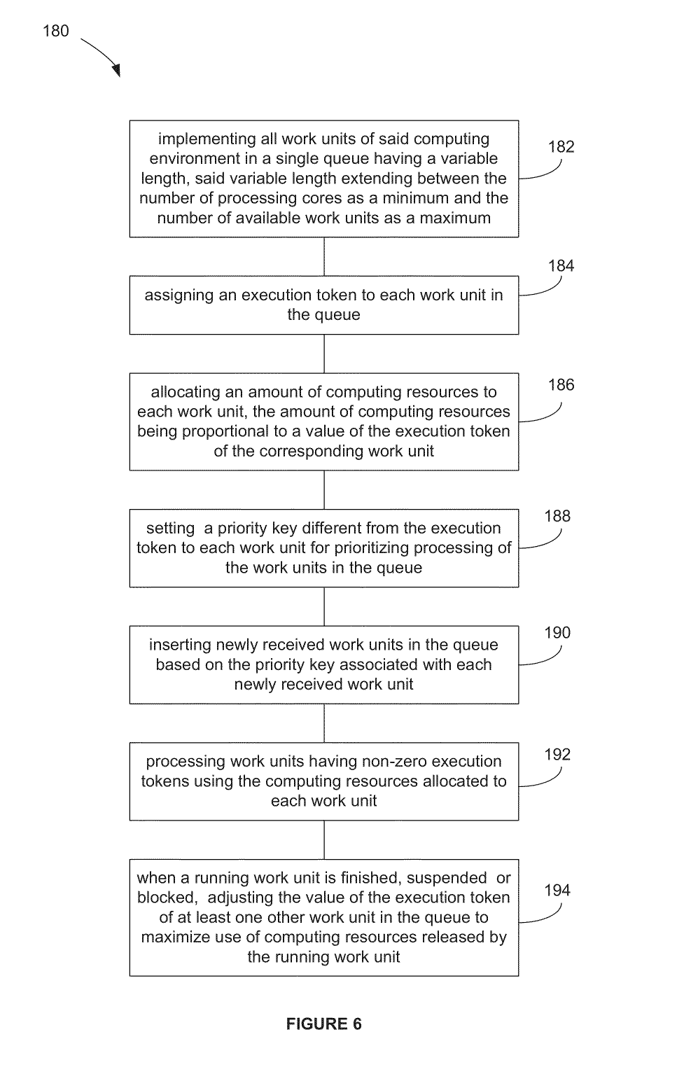

FIG. 6 is flowchart of a method for maximizing use of computing resources in a multi-core computing environment, in accordance with another embodiment. As shown in FIG. 6, the method 180 begins at step 182 by implementing all work units of said computing environment in a single queue having a variable length, said variable length extending between the number of processing cores as a minimum and the number of available work units as a maximum. Step 184 comprises assigning an execution token to each work unit in the queue. Step 186 comprises allocating an amount of computing resources to each work unit, the amount of computing resources being proportional to a value of the execution token of the corresponding work unit. Step 188 comprises setting a priority key different from the execution token to each work unit for prioritizing processing of the work units in the queue. Step 190 comprises inserting newly received work units in the queue based on the priority key associated with each newly received work unit. Step 192 comprises processing work units having non-zero execution tokens using the computing resources allocated to each work unit. Step 194 comprises adjusting the value of the execution token of at least one other work unit in the queue to maximize use of computing resources released by the running work unit when a running work unit is finished, suspended or blocked.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for maximizing use of computing resources in a multi-core computing environment, said method comprising:
implementing all work units of said computing environment in a single queue;
assigning an execution token to each work unit in the queue;
allocating an amount of computing resources to each work unit, the amount of computing resources being proportional to a value of the execution token of the corresponding work unit;
processing work units having non-zero execution tokens using the computing resources allocated to each work unit; and
when a running work unit is finished, suspended or blocked, adjusting the value of the execution token of at least one other work unit in the queue based on the amount of computing resources released by the running work unit.

2. The method of claim 1, further comprising setting a minimum length of the queue to be equal to the number of processing cores in the computing environment.

3. The method of claim 2, further comprising setting the maximum length of the queue to be equal to the number of available work units.

4. The method of claim 1, further comprising:
setting a priority key for each work unit in the queue, said priority key being different from the execution token, and having a value representing an execution priority of said work unit in the queue.

5. The method of claim 4 further comprising:
creating a dummy work adapted to consume all computing resources allocated thereto;
setting a variable execution token to said dummy work unit to allocate a variable amount/number of computing resources to said dummy work unit; and
adding said dummy work unit to said queue to consume unused computing resources.

6. The method of claim 5, further comprising setting the lowest priority key to said dummy work unit in the queue, whereby the dummy work unit is only processed when there is a lack of work units in the queue.

7. The method of claim 6, further comprising reducing the execution token of a running dummy work unit when a new work unit is added in the queue.

8. The method of claim 7, further comprising suspending a running dummy work unit when other work units in the queue consume all available computing resources in the computing environment.

9. The method of claim 1, wherein an aggregate value of all execution tokens of all work units is equal to the number of processing cores of said computing environment.

10. The method of claim 9, wherein the value of the execution token is an integer that represents the number of processing cores allocated to the corresponding work unit.

11. The method of claim 1, wherein an aggregate value of all execution tokens is greater than the number of computing resources of said computing environment, the method further comprising:
oversubscribing said processing cores; and
partitioning said processing cores among all work units in the queue.

12. The method of claim 1, wherein the shared resources include: central processing units, processing cores of a single central processing unit, memory locations, memory bandwidth, input/output channels, external storage devices, network communications bandwidth.

13. A computer having shared computing resources including at least one processor comprising a plurality of processing cores and a memory having recorded thereon computer readable instructions for execution by the processor for maximizing use of the computing resources in the computer, the instructions causing the computer to implement the steps of:
implementing all work units of said computer in a single queue;
assigning an execution token to each work unit in the queue;
allocating an amount of computing resources to each work unit, the amount of computing resources being proportional to a value of the execution token of the corresponding work unit;
processing work units having non-zero execution tokens using the computing resources allocated to each work unit; and
when a running work unit is finished, suspended or blocked, adjusting the value of the execution token of at least one other work unit in the queue to maximize use of computing resources released by the running work unit.

14. The computer of claim 13, wherein the length of the queue is variable and having a minimum which is equal to the number of processing cores in the computer and a maximum which is equal to the number of available work units.

15. The computer of claim 13, wherein the computer is adapted to set a priority key for each work unit in the queue, the priority key being different from the execution token and having a value representing an execution priority of said work unit in the queue.

16. The computer of claim 15, wherein the computer is further adapted to:
create a dummy work adapted to consume all computing resources allocated thereto;
set a variable execution token to said dummy work unit to allocate a variable amount/number of computing resources to said dummy work unit; and
add said dummy work unit to said queue to consume unused computing resources.

17. The computer of claim 16, wherein the computer is further adapted to set the lowest priority key to the dummy work unit in the queue, whereby the dummy work unit is only processed when there is no work units in the queue or when the work units in the queue cannot use all the available computing resources of the computer.

18. The computer of claim 13, wherein an aggregate value of all execution tokens of all work units is equal to the number of processing cores of said computing environment, the value of each execution token representing the number processing cores allocated to the corresponding work unit.

19. The computer of claim 13, wherein an aggregate value of all execution tokens is greater than the number of computing resources of said computing environment, the computer being further adapted to:
oversubscribe said processing cores; and
partition the processing cores among all work units in the queue.

20. A method for maximizing use of computing resources in a multi-core computing environment, said method comprising:
implementing all work units of said computing environment in a single queue having a variable length, said variable length extending between the number of processing cores as a minimum and the number of available work units as a maximum;
assigning an execution token to each work unit in the queue;
allocating an amount of computing resources to each work unit, the amount of computing resources being proportional to a value of the execution token of the corresponding work unit;
setting a priority key different from the execution token to each work unit for prioritizing processing of the work units in the queue;
inserting newly received work units in the queue based on the priority key associated with each newly received work unit;
processing work units having non-zero execution tokens using the computing resources allocated to each work unit;
when a running work unit is finished, suspended or blocked, adjusting the value of the execution token of at least one other work unit in the queue based on the amount of computing resources released by the running work unit to maximize use of computing resources in the queue.
